(19) United States
(12) Patent Application Publication
(10) Pub. No.: US 2009/0210888 A1
(43) Pub. Date: Aug. 20, 2009

(54) SOFTWARE ISOLATED DEVICE DRIVER ARCHITECTURE

(75) Inventors: Mingtzong Lee, Redmond, WA (US); Peter Wieland, Seattle, WA (US); Nar Ganapathy, Redmond, WA (US); Ulfar Erlingsson, Reykjavik (IS); Martin Abadi, Palo Alto, CA (US); John Richardson, Sammamish, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/030,868

(22) Filed: Feb. 14, 2008

(51) Int. Cl. G06F 9/54

(52) U.S. Cl. 719/321

(57) ABSTRACT

A device driver includes a hypervisor stub and a virtual machine driver module. The device driver may access device registers while operating within a virtual machine to promote system stability while providing a low-latency software response from the system upon interrupts. Upon receipt of an interrupt, the hypervisor stub may run an interrupt service routine and write information to shared memory. Control is passed to the virtual machine driver module by a reflector. The virtual machine driver module may then read the information from the shared memory to continue servicing the interrupt.

### BACKGROUND

Drivers in operating systems run in either user-mode or kernel-mode. User-mode drivers run in the non-privileged processor mode in which other application code, including protected subsystem code, executes. User-mode drivers may also run in kernels running on top of hypervisors. User-mode drivers cannot gain access to system data or hardware except by calling an application programming interface (API) which, in turn, calls system services. Kernel-mode drivers run as part of the operating system's executive, the underlying operating system component that supports one or more protected subsystems. Kernel-mode drivers may also run within hypervisors that directly access hardware.

User-mode and kernel-mode drivers have different structures, different entry points, and different system interfaces. Whether a device requires a user-mode or kernel-mode driver depends on the type of device and the support already provided for it in the operating system. Most device drivers run in kernel-mode. Kernel-mode drivers can perform certain protected operations and can access system structures that user-mode drivers cannot access. Moreover, kernel-mode drivers often offer lower-latency services. However, kernel-mode drivers can cause instability and system crashes if not implemented properly, as well as introduce security vulnerabilities.

### SUMMARY

A device driver framework in a computing system may include a virtual machine driver module, a hypervisor stub, a shared memory to share information between the virtual machine driver module and the hypervisor stub, and a reflector to manage communication between the virtual machine driver module and the hypervisor stub.

According to some implementations, the hypervisor stub may invoke an interrupt service routine in response to an interrupt received from a hardware device serviced by the virtual machine driver module. The interrupt service routine may write information from the device to the shared memory, and the virtual machine driver module may read information from the shared memory.

According to some implementations, the interrupt may be handled by an interrupt service route in the hypervisor stub and the hypervisor stub may hand off handling of the interrupt to the virtual machine driver module. The reflector may pass control of the interrupt from the hypervisor stub to the virtual machine driver, and the virtual machine driver module may access the shared memory for information written by the hypervisor stub about a device associated with the interrupt.

In some implementations, the hypervisor may be protected by a software based fault isolation mechanism.

A method may be provided that includes loading a virtual machine driver associated with a device emulated by a virtual machine, loading a hypervisor stub associated with the virtual machine driver in a hypervisor, receiving an interrupt, invoking the hypervisor stub to perform an interrupt service routine, and transferring information about the interrupt to the virtual machine driver.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is a block diagram of an implementation of a system architecture having a software isolated device driver architecture;

FIG. 2 is an operational flow of an implementation of a process performed by a virtual machine driver;

FIG. 3 is an operational flow of an implementation of a process to receive data from a device; and

FIG. 4 shows an exemplary computing environment.

### DETAILED DESCRIPTION

In operating systems such as MICROSOFT WINDOWS, a user-mode framework supports the creation of user-mode drivers that support, e.g., protocol-based or serial-bus-based devices. In some implementations, the user-mode framework may be a kernel running on top of a hypervisor.

In some implementations, drivers are written completely in the virtual machine running on top of the hypervisor (“virtual machine drivers”). Having no code within the hypervisor results in a very stable implementation. However, if some code resides in the hypervisor, a software-isolated driver model may be provided to provide generic driver functions, as described below.

In an implementation, a DMA device for the kernel running on top of the hypervisor is one that implements no device specific hypervisor code. The DMA device may make a DMA transfer by calling to the virtual machine driver. The device may have the following attributes:

1. An interrupt is edge triggered (this could be a standard line interrupt or a message-signaled interrupt). When this virtual interrupt is triggered, a signal is sent to the processing code, i.e. an Interrupt Service Routine (ISR). This ISR may be a generic handler which signals the device driver specific handler. Because the processor will not be interrupted again until the virtual interrupt is dismissed, the virtual interrupt handler may be used to service the virtual interrupt, and hence requires no device specific hypervisor code. In computing devices, there may be level triggered and edge triggered interrupts, and this model may also implement a “message based” interrupt mechanism, which has the property that an interrupt may be dismissed at a later time. With edge triggered interrupts, their dismissal may be deferred until the scheduler is able to run the virtual machine driver without any system ramifications. Level triggered interrupts, however, will continue to interrupt the system until they are dismissed, so no virtual machine code can run until that happens.

2. Interrupt information is reflected in completed buffers or in a register set which is manipulated by code in the virtual machine driver which may easily synchronize among multiple threads that access registers.

3. Level triggered interrupts that are not shared are handled. This mechanism may be implemented with a minimal amount of hypervisor code. If the interrupt is not shared, then the interrupt handler may mask the virtual interrupt at the interrupt controller (effectively blocking it) and notify the virtual machine driver to handle the device. The code in the virtual machine driver may make a request to the system (reflector, etc.) at the end of processing that unmasks the interrupt line, at which point a new interrupt may come in.

With the above, it is possible to have no device specific hypervisor code.

In other implementations, devices may have the following attributes:

1. The interrupt is level triggered. Because interrupt lines may be shared, device specific code resides in the hypervisor to dismiss the virtual interrupt after confirming that it is the source of the interrupt. These actions implement device specific knowledge.

2. Registers contain per interrupt information, i.e., they are volatile. Device specific code retains the volatile information when dismissing the interrupt. This may occur when reading the hardware registers resets the content simultaneously.

3. Checking and dismissing interrupts usually takes a read and a write to the registers for most hardware. Therefore, it is non-atomic. If drivers set up DMA in the virtual machine driver, which has to manipulate hardware registers, there may be contention between ISR and this code.

Thus, an implementation to solve the contention uses a stop-and-go strategy where a device is initialized in non-interrupting state. When the virtual machine driver receives transfer requests, it sets up one DMA transfer including enabling interrupt for the DMA transaction. The virtual machine driver then waits on the interrupt event. At some point, interrupt occurs either due to error or completion. The hypervisor ISR dismisses and disables the interrupt, by reading and writing registers, and it signals the ISR running in the virtual machine driver which processes the result. The virtual machine driver then can continue the next virtual DMA transfer if there is one. This serialization of ISR and DMA request eliminates the contention of accessing hardware registers and any shared resources.

Most hardware applications may have multiple DMA transfers outstanding for better performance. To accommodate this, the hypervisor stubs may be implemented: Stub_ISR, Stub_Reset and Stub_SyncExe. These three stubs execute at DIRQL, hence synchronization is provided for.

Stub_ISR:

This may be called by a reflector ISR wrapper as the result of an interrupt. The ISR checks the hardware status, and if it is its hardware's interrupt, the Stub_ISR dismisses the interrupt. If there is interrupt specific register content, the ISR will save it and queue it to a shared memory. The Stub_ISR returns to the reflector which signals the prearranged event object as indicated by the return code.

Stub_Reset:

In implementations, hardware will have this equivalent to a reset. The reflector initiates this function when the virtual machine driver or host terminates abruptly. This stub should ensure that hardware immediately stops unfinished DMA from further transfer. This also may be called by the virtual machine driver to reset the hardware in a device initial start or an orderly device stop.

Stub_SyncExe:

When virtual machine drivers need to synchronize accesses to hardware registers or other shared resources with other stubs, they make DeviceIoControl calls to the device in MICROSOFT WINDOWS. The calls may go through the reflector as “fast I/O” which is an optimized delivery mechanism that allows reliable I/O delivery. The reflector synchronizes with the competing stub using an appropriate mechanism (KeSynchronizeExecution for an ISR, KeAcquireSpinlock for a DPC, KeWaitForSingleObject for a passive-level stub) and then invokes the specified stub. This stub function may access a range, i.e. an in-out buffer, which the reflector sets up to carry input and output for it. This is an additional accessible range to the global accessible list for the stub. The input and output of the DeviceIoControl contains information specific to the user mode driver and kernel mode driver. In an implementation, the first field in the input buffer may be a function code, known between the stub and virtual machine drivers, so that this is a multiplex into several functions.

Software interrupts may be implemented as instructions in the instruction set, which cause a context switch to an interrupt handler similar to a hardware interrupt. Software interrupts may be the result of activity in the virtual machine running on top of a hypervisor. The virtual machine may be emulating hardware. In addition, software interrupts may results from deferred procedure calls (DPC) or an asynchronous procedure calls (APC).

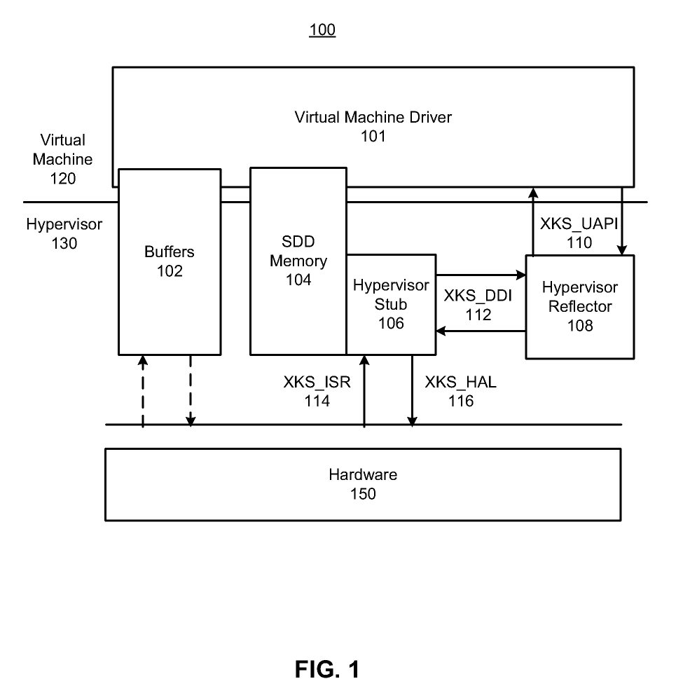

FIG. 1 is a block diagram of an implementation of a system architecture having a software isolated device driver architecture 100. A virtual machine 120 may run on top of a hypervisor 130 and include guest virtual machine kernel driver (“virtual machine driver”) 101 that may operate as part of a stack of drivers that manage hardware 150. The virtual machine driver 101 may run in any ring (e.g., ring-0, ring-1, ring-3) where the driver runs in a protected “driver-mode,” or one where the virtual machine driver is written in a safe language (e.g., C#) which can be trusted by a hypervisor 130, but which cannot be allowed to run at raised IRQL. In some implementations, the virtual machine driver 101 runs in an environment that is less trusted, such as a hosting process or a “driver execution mode” running in a carved-out section of the virtual machine's kernel protected address space.

In an implementation, to provide for hardware that requires a low-latency response, the virtual machine driver 101 may include a hypervisor stub 106. The hypervisor stub 106 may be untrusted, while executing safely in the hypervisor 130 because of a software mechanism (e.g., XFI) that allows virtual machine drivers 101 to add a stub to the hypervisor 130 without possibly corrupting the integrity of the hypervisor itself, or its subsystems. As shown, the hypervisor 130 may include a microkernel and interact directly with the hardware 150.

The hypervisor stub 106 may also provide sequencing of operations for hardware devices where certain sequences of operations are timing sensitive and cannot tolerate pauses incurred by context-switching out a virtual machine driver. Where a virtual machine driver would have to be scheduled onto a CPU to acknowledge each of the interrupts, the hypervisor stub 106 reduces this latency. The virtual machine driver 101 may support multiple devices, and therefore may multiplex requests from multiple devices through a single instance of the hypervisor stub 106. In addition, the virtual machine driver 101 may be split within the virtual machine 120, e.g., a portion may be running in user-mode within the virtual machine 120 and a portion in kernel-mode within the virtual machine 120.

The hypervisor stub 106 and virtual machine driver 101 may both have access to a region of shared memory, such as the stub device data (SDD) memory 104 to which the hypervisor stub 106 copies volatile state from the hardware. The hypervisor stub 106 may also have private memory, inaccessible to the virtual machine driver 101. This data may be multi-word and the virtual framework driver may call the kernel stub for “stub operations” that act on this data in a serialized fashion. Alternatively, the hypervisor stub 106 may place such multi-word data on a shared list, circular array, or similar data structure, using atomic operations. The SDD memory 104 may be implemented as a device data structure in one or more pages of non-pageable kernel memory, of which only a few bytes (e.g., 16 to 128 bytes) may be used. This page of memory may be double mapped with kernel-mode and virtual addresses. In an implementation, the hypervisor stub 106 write access is limited to the SDD memory 104 or a private memory, and local variables on the stack during its execution.

The virtual machine driver 101 may communicate with buffers 102. The buffers 102 provide a memory where data is buffered as it is communicated to/from the virtual machine driver 101. The buffers 102 may be allocated as a contiguous buffer or may be fragmented in the physical memory and mapped to a contiguous buffer in the calling process's virtual address space.

The hypervisor stub 106 may include a device ISR and may access multiple device control registers in a serialized fashion. Interrupts may be hardware or software-triggered events. An interrupt is an asynchronous signal from hardware or software indicating the need for attention or a synchronous event in software indicating the need for a change in execution.

The ISR performs operations such as writing volatile state information retrieved from the device to the SDD memory 104, dismissing the interrupt, and may stop the device from interrupting. The ISR may also save state information and queue a deferred procedure call to finish I/O operations at a lower priority (IRQL) than that at which the ISR executes. A driver's ISR executes in an interrupt context, at some system-assigned device interrupt request level (DIRQL).

ISRs are interruptible such that another device with a higher system-assigned DIRQL can interrupt, or a high-IRQL system interrupt can occur, at any time. On multi-processor systems, before the system calls an ISR, the interrupt's spin lock may be acquired so the ISR cannot simultaneously execute on another processor. After the ISR returns, the system releases the spin lock. Because an ISR runs at a relatively high IRQL, which masks off interrupts with an equivalent or lower IRQL on the current processor, the ISR should return control as quickly as possible. Additionally, running an ISR at DIRQL restricts the set of support routines the ISR can call.

Typically, an ISR performs the following general operations: If the device that caused the interrupt is not one supported by the ISR, the ISR immediately returns FALSE. Otherwise, the ISR clears the interrupt, saves device context, and queues a DPC to complete the I/O operation at a lower IRQL. The ISR then returns TRUE.

In drivers that do not overlap device I/O operations, the ISR determines whether the interrupt is spurious. If so, FALSE is returned immediately so the ISR of the device that interrupted will be called promptly. Otherwise, the ISR continues interrupt processing. Next, the ISR stops the device from interrupting. If the virtual framework driver 101 can claim the interrupt from the device, TRUE from its ISR, the interrupt may be dismissed. Then, the ISR gathers context information for a routine responsible for determining a final status for the current operation (e.g., DpcForIsr or CustomDpc), which will complete I/O processing for the current operation. Next, the ISR stores this context in an area accessible to the DpcForIsr or CustomDpc routine, usually in the device extension of the target device object for which processing the current I/O request caused the interrupt.

If a driver overlaps I/O operations, the context information may include a count of outstanding requests the DPC routine is required to complete, along with whatever context the DPC routine needs to complete each request. If the ISR is called to handle another interrupt before the DPC has run, it may not overwrite the saved context for a request that has not yet been completed by the DPC. If the driver has a DpcForIsr routine, call IoRequestDpc with pointers to the current I/O request packet (IRP), the target device object, and the saved context. IoRequestDpc queues the DpcForIsr routine to be run as soon as IRQL falls below DISPATCH_LEVEL on a processor. In MICROSOFT WINDOWS, if the driver has a CustomDpc routine, the KelnsertQueueDpc is called with a pointer to the DPC object (associated with the CustomDpc routine) and pointer(s) to any saved context the CustomDpc routine will need to complete the operation. Usually, the ISR also passes pointers to the current IRP and the target device object. The CustomDpc routine is run as soon as IRQL falls below DISPATCH_LEVEL on a processor. Functionally similar operations may be performed in other operation systems.

In an implementation, the hypervisor stub 106 may be executed in any ring that is granted the ability to run at a raised interrupt level and access hardware and memory. For example, hypervisor stub 106 may execute as a strictly serialized sequence of run-to-completion code at ring-0. The hypervisor stub 106 also may provide serialized, device-specific access to the SDD memory 104. This may allow the virtual framework driver to atomically clear status information out from the SDD memory 104, e.g., information about DMA requests that have completed, etc.

In an implementation, non-hardware kernel stub interfaces may be provided by a hypervisor reflector 108. The hypervisor reflector 108 may be installed at the top of a device stack for each device that a virtual machine driver 101 manages. The hypervisor reflector 108 manages communication between the kernel-mode components and the virtual machine driver host process. The hypervisor reflector 108 may forward I/O, power, and Plug and Play messages from the operating system to the driver host process, so that virtual machine drivers can respond to I/O requests and participate in Plug and Play device installation, enumeration, and management. The hypervisor reflector 108 may also monitor the driver host process to ensure that it responds properly to messages and completes critical operations in a timely manner, thus helping to prevent driver and application hangs.

FIG. 1 illustrates an implementation of interfaces to the hypervisor portion of the driver architecture 100. The interfaces may include XKS_UAPI interfaces 110 that may allow the driver 101 to interact with the hypervisor stub 106 through the reflector 108, an XKS_DDI interface 112 that may allow the kernel stub for an ISR to signal virtual code that interrupts have occurred that should be handled, an XKS_ISR interface 114 that may invoke the kernel stub implementing ISR interface upon the occurrence of hardware interrupts, and an XKS_HAL interface 116 that may contain range-checked routines for accessing memory-mapped hardware device registers.

In an implementation, the XKS_UAPI interfaces 110 include the following:

```
        NTSTATUS
XksInit( IN DeviceObject do,
        IN PVOID SharedSDD, IN ULONG SharedSDDCb,
        IN PHANDLE InterruptObjectHandles, IN ULONG
        InterruptObjectCount,
        IN PHANDLE DeviceRegisterHandles, IN ULONG
        DeviceRegisterCount,
        IN PHANDLE DevicePortHandles, IN ULONG
        DevicePortCount );
```

In an implementation, this operation allows the virtual framework driver 101 to initialize its hypervisor stub 106. The operation may specify whether a shared SDD region is created by passing a non-NULL SharedSDD, which may then be pinned and double mapped, etc. The virtual framework driver 101 (module) may pass resource handles down to the kernel stub as the three array arguments. The kernel stub uses offsets into these arrays as the first argument in the set of XKS_HAL interfaces. Thus, these arrays allow the virtual framework driver 101 and the hypervisor stub 106 to create consistent names for different device resources, e.g., the register at offset 0 is the volatile hardware interrupt status, the register at offset 3 is the volatile hardware number of bytes to read, etc. These offsets may be per resource type, so that there may be an interrupt 0, register 0, and port 0; each array pointer can be NULL if no such resources need to be accessed by the kernel stub.

In an implementation, the operation invokes a kernel stub function that may perform an operation atomically, with respect to interrupts and other SDD accesses, etc.:

| | |
|---|---|
| | NTSTATUS |
| XksOperation( | IN DeviceObject do, IN ULONG OpCode, |
| | IN PVOID InputBuffer, IN ULONG InputBufferCb, |
| | INOUT PVOID OutputBuffer, IN OutputBufferCb, |
| | OUT ULONG *BytesReturned ); |

In another implementation, if the SDD memory 104 is shared, arguments to operations and return values may be passed in SDD memory 104. This may be accomplished by using a kernel billboard (“k-board”) portion of SDD memory 104 that is reserved for writing by the hypervisor stub 106, serialized by DIRQL. The k-board is writeable by kernel (or hardware or hypervisor) but read-only to the virtual machine 120. The shared location that virtual machine driver may write to in order indicate its progress to a virtual billboard (“u-board”) is readable by hypervisor stub 106 (or hardware). The u-board portion may be reserved for writing by the virtual machine driver 101, serialized by a lock. Small arguments may be copied between the two regions using compare-and-swap operations; larger, multi-word arguments can be copied using an XksOperation. In an implementation, an XksOperation would copy-and-clear the SDD summary of information retrieved from volatile hardware memory on interrupts, i.e., copy summary data from the k-board into the u-board, and clearing the k-board interrupt summary.

In an implementation, the hypervisor reflector 108 may send an “interrupt event” to the virtual machine driver 101 by signaling an event in a DPC:

UPCALL_EVENT XksInterruptEvent

In another implementation, an IPC mechanism may be used to wake up the interrupt thread rather than events.

In an implementation, the XKS_DDI interface 112 may include upcall and downcall interfaces. The upcall interface for kernel stub to call the reflector, may be:

VOID
XksDDI_SignalInterrupt ( );

The hypervisor reflector 108 may invoke the hypervisor stub 106 to handle requests for “stub operations” in response to XksOperation calls in the XKS_UAPI. The hypervisor reflector 108 may call a kernel stub interface at DIRQL holding the proper locks in a manner that allows for safe execution of the hypervisor stub 106 using XFI. In an implementation, the downcall interface for the hypervisor reflector 108 to call a stub operation could be:

```
NTSTATUS
XksDDI_StubOperation( IN SDD* deviceData, IN ULONG
lengthOfSDD,
                        IN LONG opcode,
                        IN PVOID InputBuffer, IN ULONG
                        InputBufferCb,
                        INOUT PVOID OutputBuffer, IN
                        OutputBufferCb,
                        OUT ULONG *BytesReturned );
```

Negative opcode numbers may be reserved for definition by the virtual driver 101. In an implementation, negative one (−1) is XKS_STOP_ALL_INTERRUPTS_FROM_HARDWARE_DEVICE, which the hypervisor stub 106 handles by disabling the generation of interrupts from the hardware device.

In an implementation, the XKS_ISR interface 114 may be implemented by a small shim in the hypervisor reflector 108. An exemplary ISR interface may be:

```
                  BOOLEAN
                  XSR_InterruptService( IN SDD* deviceData,
IN ULONG lengthOfSDD, IN ULONG interruptID );
```

The above routine may obtain a pointer to the SDD memory 104 as an SDD pointer. It may also discriminate which interrupt this is by, e.g., requiring that the virtual framework driver register separate ISR routines for different interrupt lines/messages, if the hardware uses multiple such lines. In an implementation, the above routine should return FALSE if the hardware device is not interrupting, but otherwise handles the interrupt to completion and returns TRUE.

In an implementation, the XKS_HAL interface 116 may include routines for reading and writing in 1-byte, 2-byte, 4-byte (and on x64, 8-byte increments), i.e., for chars, shorts, longs, etc. The XKS_HAL may be implemented as accessor methods that go through the virtual framework reflector.

The routines have the same prototypes as the HAL APIs, shown below for bytes:

```
      VOID WRITE_REGISTER_UCHAR( IN XKS_HANDLE Reg,
      IN UCHAR Value );
      VOID WRITE_REGISTER_BUFFER_UCHAR( IN
XKS_HANDLE Reg, IN PUCHAR Buffer, IN ULONG Count );
      UCHAR READ_REGISTER_UCHAR( IN XKS_HANDLE
      Reg );
      VOID READ_REGISTER_BUFFER_UCHAR( IN
XKS_HANDLE Reg, IN PUCHAR Buffer, IN ULONG Count );
```

The HAL operations may refer to hardware resources as XKS_HANDLE, which may be offsets into the array passed down in the XksInit operation. The XKS_HANDLE handles may be mapped to actual resource addresses in a manner that can be trusted, e.g., by invoking accessor code in the virtual framework reflector 108, or through use of the software based fault isolation mechanism (XFI). In some implementations, the handles may be the actual addresses of memory-mapped hardware registers. In either case, they may be bounds checked, so that the hypervisor stub 106 cannot overflow a memory-mapped device control region.

In the implementations above, the virtual machine driver 101 may pass the names of handles down to the hypervisor stub 106 in a device-specific manner. This may be implemented using a structure in the u-board in the SDD memory 104. In addition to the above, accessor methods for I/O ports may be provided. In an implementation, support routines (implemented as macros) that manipulate linked lists and other data structures resident in the SDD memory 104 may be provided.

In an implementation, the virtual machine driver 101 may refer to the hypervisor stub 106 by invoking the interfaces 110 and by sharing the same logic and data structures (e.g. through a common header file) with the hypervisor stub 106. The hypervisor stub 106 may manipulate variables on the stack, as well as hardware device registers, and has write access to a small region of memory. The hypervisor stub 106 may export several names (e.g., DriverEntry) that may be defined kernel stub entry points.

The hypervisor stub 106 may refer to portions of the SDD memory 104 that are shared with the virtual machine driver 101 and that are private. In an implementation, this may be performed by having the kernel stub source code define global variables with reserved names (e.g., PrivateSDD_Struct and SharedSDD_Struct) that are turned into device-local references by the XFI rewriter. This may make all global variables into device-global variables for hypervisor stub 106.

The stack can be used to hold most of the writable relevant data, including the allocation stack. Alternatively, since the ISR code may be strictly serialized, the allocation stack, SDD, and INIT data may all be stored in a single, contiguous region of non-paged memory. This region may be used to hold writable global variables present in the hypervisor stub 106.

The stack may hold a deviceObject or interruptObject like data structure that serves as a point of indirection for kernel stub memory activity. This object may also be passed along from the hypervisor stub 106 whenever it accesses support routines. A pointer to this object may be stored in a reserved, immutable register (e.g., EBP) or it may be passed along as an extra implicit argument to the functions in the hypervisor stub 106, e.g., with the code written to do this explicitly or, alternatively, to provide a more attractive programming model, the programmers of hypervisor stub 106 could reference a global variable that is properly expanded by the rewriter.

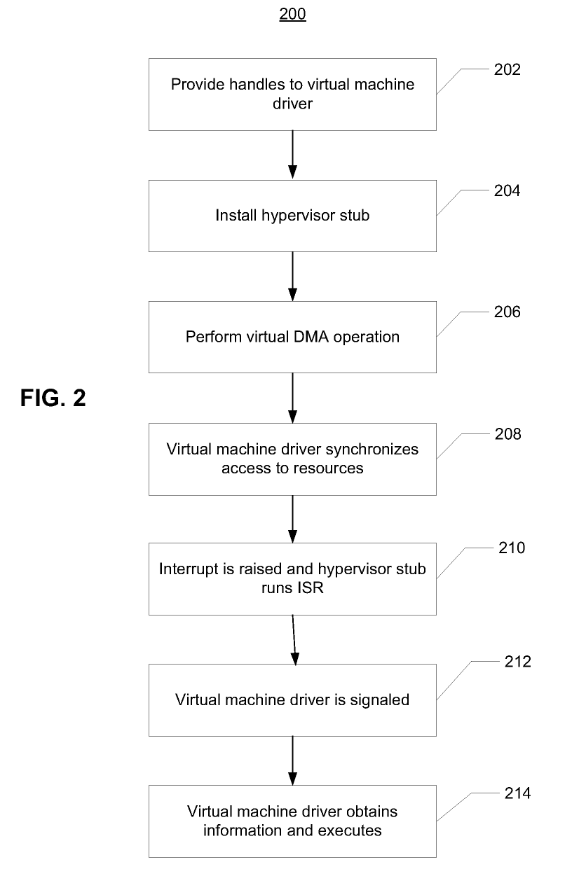

FIG. 2 is an exemplary process 200 performed with the architecture 100. At 202, a virtual machine driver provided handles to the hardware resources assigned to it. This may include handles to memory-mapped registers, interrupt objects, etc. At 204, the hypervisor stub 106 is installed and INIT data is provided summarizing information to the stub. This may include information obtained at 202 regarding hardware researches, handles etc. The hypervisor stub 106 may be installed in the in the SDD memory 104.

At 206, the virtual machine driver code prepares a DMA transfer. The virtual machine driver 101 may invoke the hypervisor stub 106 to perform device programming for this DMA operation.

At 208, the device driver synchronizes access to hardware resources or shared resources. SyncExecution may be performed to start the DMA transfer. The virtual machine drivers may synchronize accesses to registers or shared resources by making DeviceIoControl calls to the device. The calls go through the hypervisor reflector 108 which calls this stub function with KeSynchronizeExecution. This stub function may access a range, i.e. an in-out buffer, which the reflector sets up to carry input and output for it.

At 210, a hardware device raises an interrupt. Executable code within hypervisor stub 106 for the ISR is invoked that copies volatile device state into the SDD memory 104. At 212, the virtual machine driver is signaled. This may be performed through the ISR execution.

At 214, virtual machine driver code executes to obtain information about the interrupt. The may be performed by copying and clearing bits from the SDD memory 104 (i.e., calling a kernel stub operation for multi-word information). For instances where unsynchronized access to the SDD memory 104 is safe, e.g., when it is a distinct word of memory that can be accessed atomically, the virtual code can just read or write the SDD memory 104. In the other cases, the virtual machine driver 101 may call the hypervisor stub 106 to synchronize with the ISR, copy the state of the SDD memory 104 into a buffer, and then release the interrupt lock and return. If a hardware device programmed to perform multiple operations sends an interrupt whenever each operation completes, the ISR within the hypervisor stub 106 may acknowledge the interrupts at 214 to allow operations to complete as soon as possible. If a hardware device only performs one DMA operation at a time and interrupts when done, the hypervisor stub 106 may acknowledge interrupts for completed DMA at 214 and issue new DMA operations. The may be performed by maintaining a list of completed DMA operations and a list of future DMA operations to issue in the SDD memory 104.

Stages 206 through 214 may be repeated for multiple outstanding types of hardware operations, and multiple types of events may be signaled in 210 and 214.

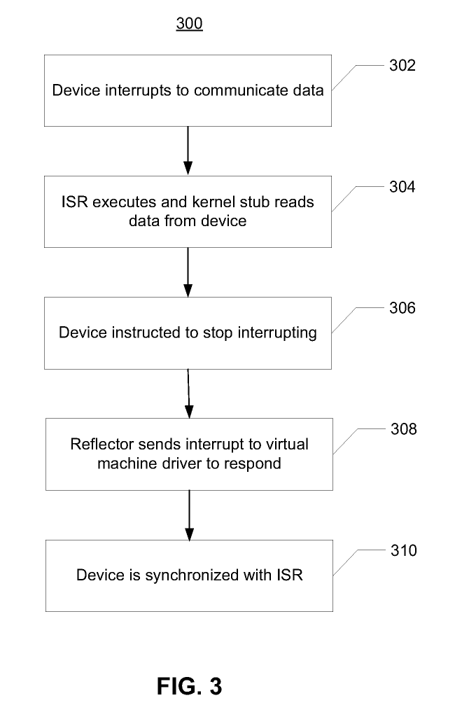

FIG. 3 is an exemplary process 300 of processing data received from a device communicating to computing system using the implementations of FIGS. 1 and 2. The received data may be a packet received from a peripheral, such as a network device. At 302, when a packet comes in to the virtual network device, an interrupt is triggered by the network device. This may include a call to the XKS_ISR interface 114. At 304, information about the network packet is read out of the network device. This may be performed by the hypervisor stub 106. At 306, the device is instructed to stop interrupting. Device driver interfaces (XKS_DDI 112) may be used to manage the network device and to inform the hypervisor stub 106 to finish processing the interrupt. The XKS_DDI 112 may also inform the hypervisor reflector 108 that an interrupt was received and the information needs to be recorded.

At 308, the hypervisor reflector 108 sends a software interrupt to the virtual machine driver 101 to take control of the processing. At 310, the hardware is stopped from doing any additional work, so that the virtual machine driver 101 may synchronize access with registers and other resources.

Below is an example of real-time audio processing using the split virtual/kernel-mode driver architecture of FIGS. 1-3. For real-time audio processing, the audio hardware exposes DMA memory to virtual machine driver 101 which can read the progress from a shared hardware location (e.g., SDD memory 104) and produce/consume to the proper extent. The virtual machine driver 101 writes to SDD memory 104 to indicate its progress. The audio hardware reads the progress and does not exceed it when performing a Write to devices, nor falls behind in performing a Read from devices. In this scenario, the hypervisor stub 106 may run in the stream setup, while idling during the steady streaming state.

The SDD memory 104 may be split into a virtual and kernel-mode bulletin board, where the hypervisor stub 106 (or hardware) writes to indicate its progress to a kernel billboard. The k-board is writeable by kernel (or hardware or hypervisor 130) but read-only to virtual machine 120. The share location that virtual machine driver writes to indicate its progress to a virtual billboard is readable by hypervisor stub 106 (or hardware). In another implementation, the hypervisor stub 106 updates k-board and the virtual machine driver 101 may wake and check the state periodically or by events.

In an implementation, Table 1 below is a timeline of events to setup DMA and interrupts in the real-time audio example above. Time progresses moving downward in Table 1.

TABLE 1

| | Virtual code (Virtual | | Hypervisor code in the |
|---|---|---|---|
| Application | machine driver) | Hypervisor stub | Reflector |
| | Receive DMA Resources | | |
| | GetMappedResource( ) | | Map to user mode |
| | SetupSDD(pBuff, size) | | ProbeAndLock(pBuff) |
| | Create UISR thread | | |
| | Post UISR event | | |
| | UISR thread waits on | | |
| | UISR event | | |
| Read(pBuffer1, size1) | GetPhysicalAddr(irp1) | | |
| | DeviceIoControl(Fill in | | |
| | DMA control for irp1) | | |
| | | | KeSynchronizeExecution |
| | | | Kernel Stub |
| | | Fill in DMA control for | |
| | | irp1 | |
| | | Start DMA | |
| Read(pBuffer2, size2) | GetPhysicalAddr(irp2) | | |
| | DeviceIoControl(Fill in | | |
| | DMA control for irp2) | | |
| | | | KeSynchronizeExecution |
| | | | Kernel Stub |
| | | Fill in DMA control for | |
| | | irp2 | |
| | | | Gets interrupt |
| | | XKS_ISR invoked | |
| | | Get volatile info and | |
| | | dismiss int | |
| | | Update k-board in SDD | |
| | | Byteseq = x | |
| | | | Setup DPC to |
| | | | Signal UISR event |
| | UISR checks k-board in | | |
| | the SDD if byteseq >= end | | |
| | of pBuffer1, | | |
| | complete irp1 check | | |
| | pBuffer2 similarly | | |
| Get pBuffer1 | | | |
| Read(pBuffer3, size3) | . . . | | |
| . . . | | | |

### Exemplary Computing Arrangement

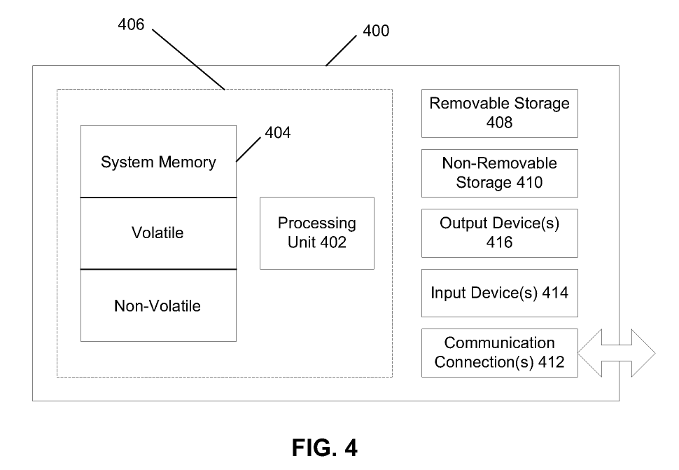

FIG. 4 shows an exemplary computing environment in which example implementations and aspects may be implemented. The computing system environment is only one example of a suitable computing environment and is not intended to suggest any limitation as to the scope of use or functionality.

Numerous other general purpose or special purpose computing system environments or configurations may be used. Examples of well known computing systems, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 4, an exemplary system for implementing aspects described herein includes a computing device, such as computing device 400. In its most basic configuration, computing device 400 typically includes at least one processing unit 402 and memory 404. Depending on the exact configuration and type of computing device, memory 404 may be volatile (such as random access memory (RAM)), non-volatile (such as read-only memory (ROM), flash memory, etc.), or some combination of the two. This most basic configuration is illustrated in FIG. 4 by dashed line 406.

Computing device 400 may have additional features/functionality. For example, computing device 400 may include additional storage (removable and/or non-removable) including, but not limited to, magnetic or optical disks or tape. Such additional storage is illustrated in FIG. 4 by removable storage 408 and non-removable storage 410.

Computing device 400 typically includes a variety of computer readable media. Computer readable media can be any available media that can be accessed by device 400 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 404, removable storage 408, and non-removable storage 410 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 400. Any such computer storage media may be part of computing device 400.

Computing device 400 may contain communications connection(s) 412 that allow the device to communicate with other devices. Computing device 400 may also have input device(s) 414 such as a keyboard, mouse, pen, voice input device, touch input device, etc. Output device(s) 416 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be affected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method, comprising:
loading a virtual machine driver associated with a device in a virtual machine;
loading a hypervisor stub associated with the virtual machine driver in a hypervisor;
receiving an interrupt;
invoking the hypervisor stub to perform an interrupt service routine; and
transferring information about the interrupt to the virtual machine driver.

2. The method of claim 1, further comprising:
invoking the hypervisor stub to perform programming of the device using a virtual direct memory access operation.

3. The method of claim 1, further comprising:
protecting the hypervisor from faults using a software based fault isolation mechanism.

4. The method of claim 1, further comprising:
providing the hypervisor stub access to a shared memory space that is shared between the hypervisor stub and the virtual machine driver.

5. The method of claim 4, further comprising:
copying device state data into the shared memory space in response to the interrupt.

6. The method of claim 5, further comprising:
synchronizing copying and clearing bits between the hypervisor stub and the virtual machine driver from the shared memory space.

7. The method of claim 1, further comprising:
emulating a device within the virtual machine; and
receiving the interrupt from the virtual machine driver.

8. A method, comprising:
receiving an interrupt from a device emulated in a virtual machine;
executing an interrupt service routine in a hypervisor stub;
reading information from the hardware device by the hypervisor stub;
storing the information in a shared memory; and
sending the interrupt to a virtual machine driver.

9. The method of claim 8, further comprising:
managing communication between the hypervisor stub and the virtual machine driver using a reflector; and
stopping the hardware device by the reflector when the virtual machine driver associated with the hardware device terminates.

10. The method of claim 9, further comprising:
providing an upcall and downcall interface to synchronize communication between the hypervisor stub and the virtual machine driver.

11. The method of claim 8, further comprising:
sharing information between the virtual machine driver and the hypervisor stub regarding the hardware device and the interrupt in the shared memory.

12. The method of claim 11, further comprising:
synchronizing the storing and reading such that only one of the hypervisor stub or the virtual machine driver can write the shared memory space.

13. The method of claim 11, further comprising:
passing resource handles to the hypervisor stub in the shared memory space; and
passing arguments to operations and return values in the shared memory space.

14. The method of claim 8, further comprising:
synchronizing the virtual machine driver access with system resources.

15. A device driver framework in a computing system, comprising:
a virtual machine driver module;
a hypervisor stub running on top of hardware within the computing system;
a shared memory to share information between the virtual machine driver module and the hypervisor stub; and
a reflector to manage communication between the virtual machine driver module and the hypervisor stub.

16. The device driver framework of claim 15, wherein the hypervisor stub invokes an interrupt service routine in response to an interrupt received from a hardware device serviced by the virtual machine driver module.

17. The device driver framework of claim 16, wherein the interrupt service routine writes information from the device to the shared memory, and wherein the virtual machine driver module reads information from the shared memory.

18. The device driver framework of claim 15, wherein the interrupt is handled by an interrupt service route in the hypervisor stub and wherein the hypervisor stub passes handling of the interrupt to the virtual machine driver module.

19. The device driver framework of claim 18, wherein the reflector passes control of the interrupt from the hypervisor stub to the virtual machine driver, and wherein the virtual machine driver module accesses the shared memory for information written by the hypervisor stub about a device associated with the interrupt.

20. The device driver framework of claim 15, wherein the hypervisor is protected by a software based fault isolation mechanism.
